(19) United States
(12) Patent Application Publication
(10) Pub. No.: US 2005/0282498 A1
(43) Pub. Date: Dec. 22, 2005

(54) FM stereo modulator

(76) Inventor: Henry Chen, Arcadia, CA (US)

Correspondence Address: PAI PATENT & TRADEMARK LAW FIRM, 1001 FOURTH AVENUE, SUITE 3200, SEATTLE, WA, 98154, US

(21) Appl. No.: 10/869,114

(22) Filed: Jun. 16, 2004

(51) Int. Cl. H04B 1/034

(52) U.S. Cl. 455/66.1; 455/95

(57) ABSTRACT

A FM stereo modulator is disclosed and claimed for modulating/converting the audio output signal of a portable music player into a FM signal receivable by the FM tuner of a stereo system. It comprises an electrically insulating hollow enclosure, a power connector connected by a first cable to one end of the enclosure for connection to external power supply, a music source connector connected by a second cable to the other end of the enclosure which is connectable to the audio output terminal of a portable music player, and a FM modulating circuit mounted inside the enclosure and electrically connected to the power connector and to the music source connector for modulating the audio output signal of the portable music player connected to the music source connector into FM tuner receivable radio signal with one of carrier frequencies selected by the user.

### BACKGROUND OF THE INVENTION

1. Field of the Invention

The present invention relates to a FM stereo modulator. More particularly, it relates to a FM stereo transmitter that converts audio signal into FM signal then transmits the FM signal through an antenna at certain user-selectable frequencies.

2. Description of the Related Art

With the fast development and advancement in consumer electronics, a variety of music players, such as portable MP3 players, MD players, and CD players, have been developed and have gained popularity in the marketplace. Users of these portable music playing devices commonly enjoy the music with an earphone. Due to lack of interface between the stereo system and the portable device, it is not possible to use a portable music playing device with an auto stereo system unless a cassette adapter is used. Moreover, it is difficult to find auto stereo systems with such cassette features these days. Consequently, it is very inconvenient, if not impossible, to use a portable music playing device with an auto stereo system in an automobile.

### BRIEF SUMMARY OF THE INVENTION

In light of the above, the object of the present invention is to provide a convenient link between the portable music playing device and the stereo system by converting the audio output from the portable music playing device to FM stereo signal receivable by the FM tuner in a stereo system. We call the device providing such a link “FM Stereo Modulator”.

To achieve this and other objects of the present invention, the FM stereo modulator comprises an enclosure, a power connector, a music source connector, and a FM modulating circuit mounted inside the enclosure.

The power connector includes both the positive and negative contacts and optionally a charging circuitry. The casings of the enclosure form a cavity to house the FM modulating circuit. The power connector is linked via a cable to one end of the enclosure. Another cable connected with the music source connector is extended outside of the other end of the enclosure. When the contacts are connected to a power source and the music source connector is inserted into the audio output terminal of a portable music playing device, the FM stereo modulator receives both the needed operating electricity and audio signal. Then the FM stereo modulator through the FM modulating circuit converts the audio signal received into FM stereo signal and transmits it through the antenna at one of the 8 user selected frequencies receivabled by a FM tuner.

### BRIEF DESCRIPTION OF THE DRAWINGS

FIG. 1 illustrates the outer appearance of a FM stereo modulator according to the present invention.

FIG. 2 is a system block diagram of the present invention.

FIG. 3 illustrates an alternate embodiment of the FM stereo modulator according to the present invention.

FIG. 4 illustrates the circuit layout of the first side of the circuit board of the FM modulating circuit for the FM stereo modulator according to the present invention.

FIG. 5 illustrates the circuit layout of the second side of the circuit board of the FM modulating circuit for the FM stereo modulator according to the present invention.

### DETAILED DESCRIPTION OF THE PREFERRED EMBODIMENT

To illustrate the abovementioned functions and features of the present invention, the preferred embodiments of the FM stereo modulator according to the present invention are described in detail below:

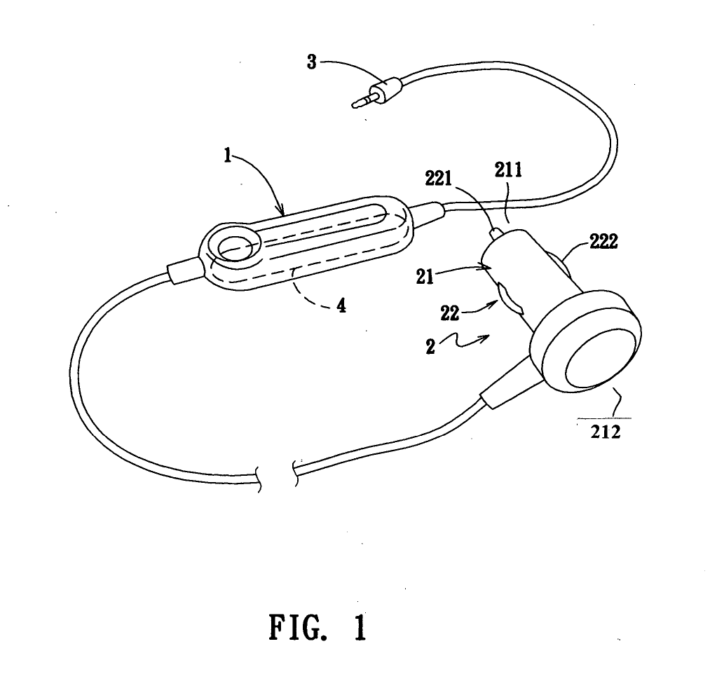

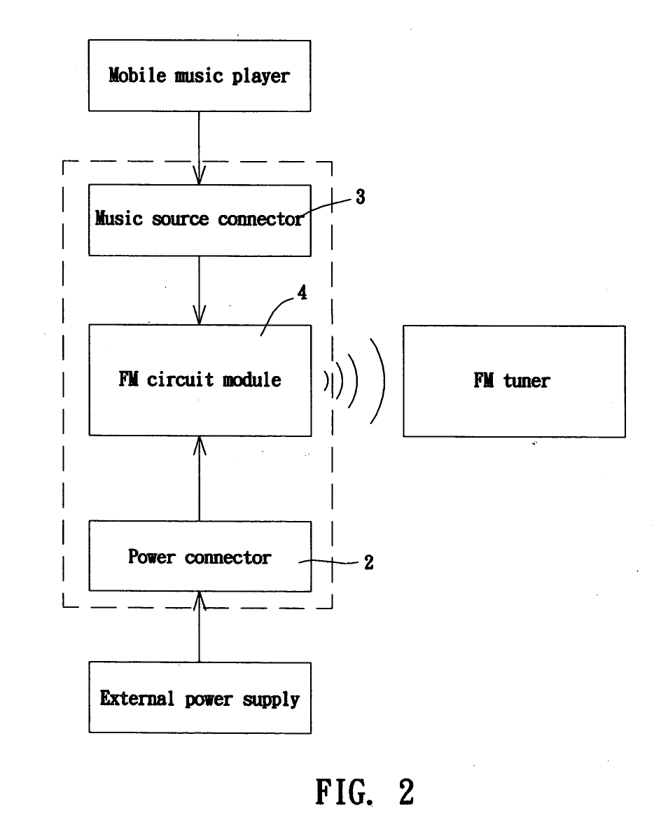

A FM stereo modulator modulates the audio output signal of a portable music playing device, for example, a MP3 player, into FM stereo signal that is receivable by an automobile FM tuner. Referring to FIGS. 1 and 2, a FM stereo modulator according to the present invention comprises an enclosure 1, a power connector 2, a music source connector 3, and a FM modulating circuit 4.

The enclosure 1 is a hollow elongated plastic shell having two rounded ends and defining therein a receiving space.

The power connector 2 is extended with a cable from one end of the enclosure 1 and comprises a plug 21 and a power head 22. The plug 21 has a front side 211 and a rear side 212. The power head 22, integral with the plug 21, protrudes from the front side 211 of the plug 21. According to this embodiment, the power head 22 comprises a center contact 221 axially forwardly protruding from the front side 211 of the plug 21, and two metal spring contacts 222 bilaterally protruding from the periphery of the plug 21. This design makes the power connector 2 connectable to the electric socket for cigarette lighter in an automobile or similar power output socket means in a ship, airplane, office, or house to obtain the necessary operating voltage.

The music source connector 3 is extended with a cable from the other end of the enclosure 1 and connectable to the audio output terminal of a portable music player. The music source connector 3 can be a 3.5 mm earphone plug or 2.5 mm earphone plug. The cable of the music source connector 3 has the function of an antenna.

The power connector 2 may optionally include a circuitry for charging the portable music player connected to the music source connector 3.

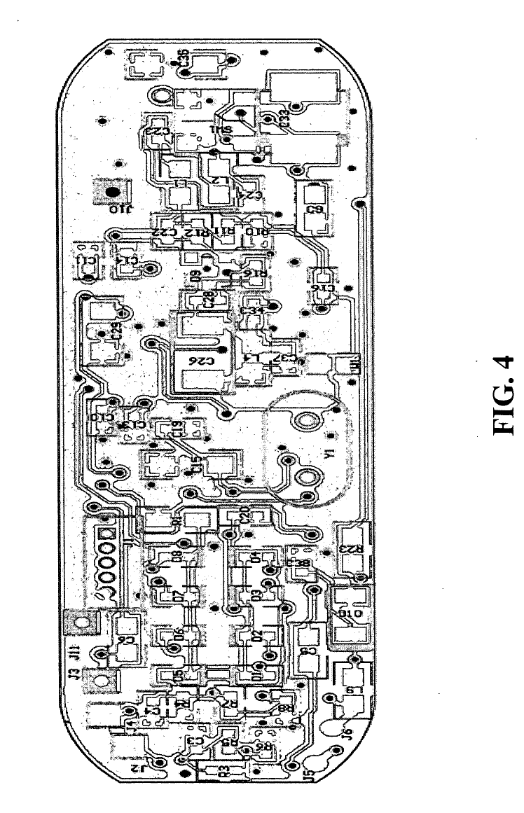

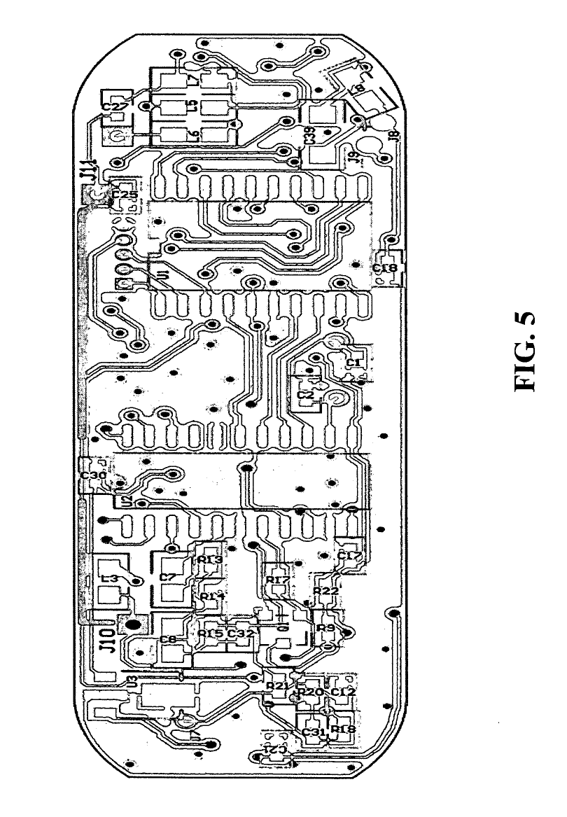

The FM modulating circuit 4, as shown in FIGS. 4 and 5, is a monolithic circuit board mounted inside the enclosure 1 and electrically connected to the power connector 2 and the music source connector 3. The FM modulating circuit 4 obtains the necessary operating voltage from the power connector 2, and modulates the audio output signal of the portable music player, to which the music source connector 3 is connected, into radio signal with one of the eight carrier frequencies: 88.1 MHz, 88.3 MHz, 88.5 MHz, 88.7 MHz, 88.9 MHz, 89.1 MHz, 89.3 MHz, and 89.5 MHz (other frequency combinations are possible), which can then be transmitted through an antenna. Therefore, the audio output signal of the portable music player is carried to the FM tuner of the automobile stereo system without any physical link. Consequently, it greatly increases the portability of the portable music playing devices, and conveniently allows the music from the portable music playing devices to be enjoyed in many settings, such as home, office, etc.

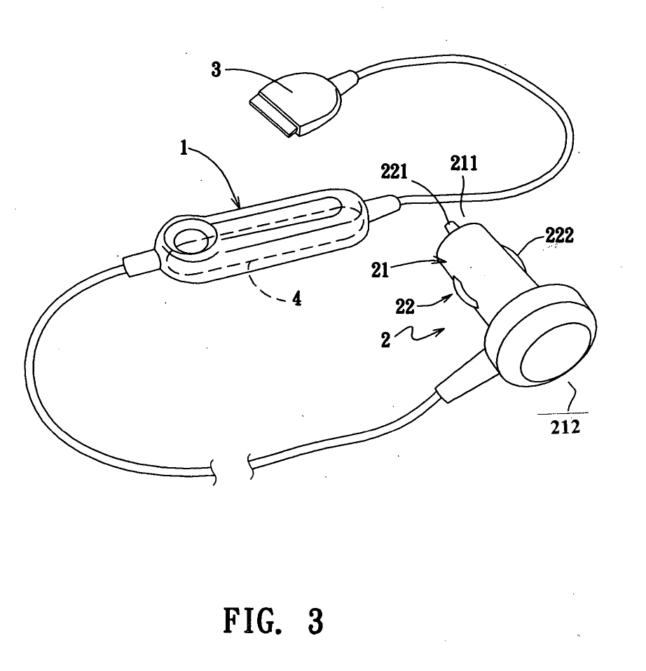

FIG. 3 illustrates an alternate embodiment of the present invention. This embodiment is substantially similar to that shown in FIG. 1 with the exception of the type of the music source connector 3. According to this design, the music source connector 3 is connectable to the MP3 player “iPOD” manufactured by Apple Computer Inc.

In conclusion, the present invention ‘FM stereo modulator’ described above can achieve its intended objectives mentioned above. Additionally, it has not been disclosed in any publications or available in public.

Although two particular embodiments of the present invention have been described in detail for illustration purposes, various modifications and enhancements may be made without departing from the spirit and scope of this invention.

1. A FM stereo modulator for modulating the audio output signal of a portable music player into a FM signal and transmitting the FM signal at certain carrier frequencies through an antenna, comprising:
an electrically insulating hollow enclosure;
a power connector connected to a first cable extended outwards from one end of said enclosure and connectable to an external power source;
a music source connector connected to a second cable extended outwards from an opposite end of said enclosure and connectable to the audio output terminal of a portable music player for receiving the audio output signal from the portable music player; and
a FM modulating circuit mounted inside said enclosure and electrically connected to the power connector and to the music source connector for modulating the audio output signal of the portable music player connected to said music source connector into a FM radio signal with one of a series of carrier frequencies receivable by a FM tuner.

2. The FM stereo modulator as claimed in claim 1, wherein said power connector is an electric plug connectable to the power socket for cigarette lighter in an automobile.

3. The FM stereo modulator as claimed in claim 1, wherein said music source connector is a 3.5 mm earphone plug.

4. The FM stereo modulator as claimed in claim 1, wherein said music source connector is a 2.5 mm earphone plug.

5. The FM stereo modulator as claimed in claim 1, wherein said music source connector is connectable to iPOD, which is a MP3 player produced by Apple Computer Inc.

6. The FM stereo modulator as claimed in claim 1, wherein said series of carrier frequencies includes 88.1 MHz, 88.3 MHz, 88.5 MHz, 88.7 MHz, 88.9 MHz, 89.1 MHz, 89.3 MHz, and 89.5 MHz.

7. The FM stereo modulator as claimed in claim 1, wherein the cable connected to said music source connector has the function of an antenna.

8. The FM stereo modulator as claimed in claim 1, wherein the power connector further includes a circuitry for charging the portable music player connected to the music source connector.
